(19) United States
(12) Patent Application Publication
(10) Pub. No.: US 2013/0283303 A1
(43) Pub. Date: Oct. 24, 2013

(54) APPARATUS AND METHOD FOR RECOMMENDING CONTENT BASED ON USER'S EMOTION

(71) Applicants: Hwa-Shin MOON, Daejeon-si (KR); Cho-Rong YU, Daejeon-si (KR); Jae-Chan SHIM, Daejeon-si (KR); Dong-Hun LEE, Daejeon-si (KR); Hwa-Suk KIM, Daejeon-si (KR); Kee-Seong CHO, Daejeon-si (KR)

(72) Inventors: Hwa-Shin MOON, Daejeon-si (KR); Cho-Rong YU, Daejeon-si (KR); Jae-Chan SHIM, Daejeon-si (KR); Dong-Hun LEE, Daejeon-si (KR); Hwa-Suk KIM, Daejeon-si (KR); Kee-Seong CHO, Daejeon-si (KR)

(73) Assignee: ELECTRONICS AND TELECOMMUNICATIONS RESEARCH INSTITUTE, Daejeon-si (KR)

(21) Appl. No.: 13/617,362

(22) Filed: Sep. 14, 2012

(30) Foreign Application Priority Data
Apr. 23, 2012 (KR) 10-2012-0042255

(51) Int. Cl. H04N 21/258

(52) U.S. Cl. 725/10

(57) ABSTRACT

An apparatus for recommending content based on a user's emotion. The apparatus includes an emotion information acquiring unit configured to acquire emotion information of a user at the time of use of particular content; an emotion information managing unit configured to store and manage emotion information corresponding to the particular content; and a content recommending unit configured to search for and recommend content corresponding to an emotion-descriptive word which is input by the user to request content search.

### CROSS-REFERENCE TO RELATED APPLICATION

This application claims the benefit under 35 U.S.C. §119(a) of Korean Patent Application No. 10-2012-0042255, filed on Apr. 23, 2012, the entire disclosure of which is incorporated herein by reference for all purposes.

### BACKGROUND

1. Field

The following description relates to a content providing apparatus and method, such as an Internet protocol (IP) TV platform, and more particularly, to a method for searching for and recommending content.

2. Description of the Related Art

Generally, content search and recommendation is conducted based on metadata of content. A user inputs content-related search information, such as the name of content, a main character, cast, and the genre of the content, to a search engine provided by a content providing platform or the Internet to request content recommendations.

In this case, recommendation results may be limited to information that only relates to the metadata of the content that is based on information that the user comes up with. However, the metadata of content is not adequate as search information. For example, when a service user feels depressed, the user may want movies to change their current mood regardless of the usual preference of film genre or actors or actresses. In other words, the user may want films that make the user laugh or cry, giving an emotional catharsis, or the user may not be sure about the exact genre of film that they want to watch.

When being in a particular emotional state, a user may want different content, apart from the usual preference, and in this case, the user may have difficulties finding desired content if only based on the user's existing knowledge. Hence, there may be a content search and recommendation method required for providing content recommendations suitable to a search term indicating a user's emotion, such as depression.

In this regard, there are music selection devices to recommend music based on a user's emotional state. These devices convert user's emotions into numeric data, and recommend music of a specific genre based on the converted numeric data (additionally, contextual information such as time and age). However, unlike music, movies include various forms of media data, and thus there may be a low relevance between their genres and the user's emotions. As described above, some users may prefer comedy movies but others may want sad movies when they feel depressed.

Thus, there is a need of an emotion-based recommendation method for content such as movies, which ensures a high level of satisfaction.

### SUMMARY

The following description relates to an apparatus and method for recommending multimedia content such as movies based on an emotion keyword.

In addition, the following description relates to an apparatus and method for recommending content based on a user's emotion, by using a database storing acquired emotion information of the user with respect to each content.

In one general aspect,

Other features and aspects will be apparent from the following detailed description, the drawings, and the claims.

### BRIEF DESCRIPTION OF THE DRAWINGS

FIG. 1 is a diagram illustrating an apparatus for recommending content based on an emotion according to an exemplary embodiment of the present invention.

FIG. 2 is a diagram illustrating in detail the emotion information acquiring unit of FIG. 1.

FIG. 3A is a flowchart illustrating a method of acquiring emotion information according to an exemplary embodiment of the present invention.

FIG. 3B is a flowchart illustrating a method of acquiring user satisfaction with recommendation after viewing recommended content.

FIG. 4 is a diagram illustrating an example of a data table managed by the emotion information managing unit of FIG. 1.

FIG. 5 is a flowchart illustrating a method of recommending content based on an emotion according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An apparatus and method described herein obtain information on a user's emotional state while a user is viewing content, build database using the obtained information on the user's emotional state, and search for and recommend emotion-based content based on the managed data.

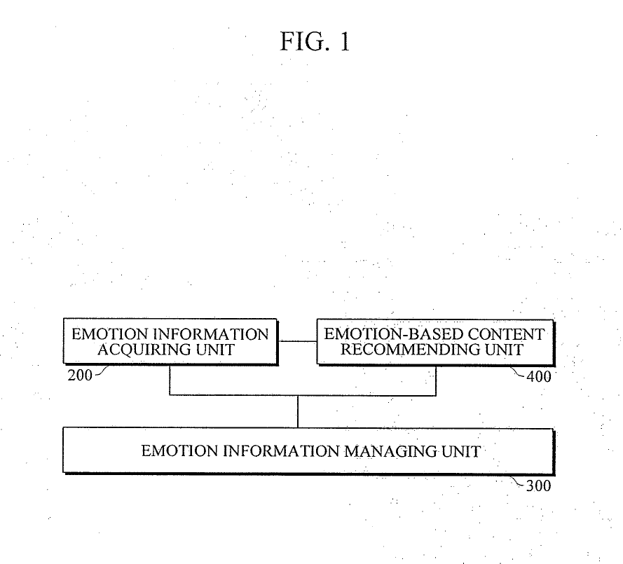

FIG. 1 is a diagram illustrating an apparatus for recommending content based on an emotion according to an exemplary embodiment of the present invention.

Referring to FIG. 1, the apparatus includes an emotion information acquiring unit 200, an emotion information managing unit 300 and an emotion-based content recommending unit 400.

The emotion information acquiring unit 200 may extract information on a user's emotional state at the time of viewing content, and transmit the extracted information to the emotion information managing unit 300. In addition, the emotion information acquiring unit 200 may acquire information about a level of user satisfaction with recommended content after viewing the content, and transmit the acquired satisfaction information to the emotion information managing unit 300.

The emotion information managing unit 300 may manage the data input from the emotion information acquiring unit 200 on the individual content and user basis.

The emotion-based content recommending unit 400 may search for and recommend content based on the data managed by the emotion information managing unit 300 in response to a request from the user for content search and recommendation using the user emotion information as a keyword.

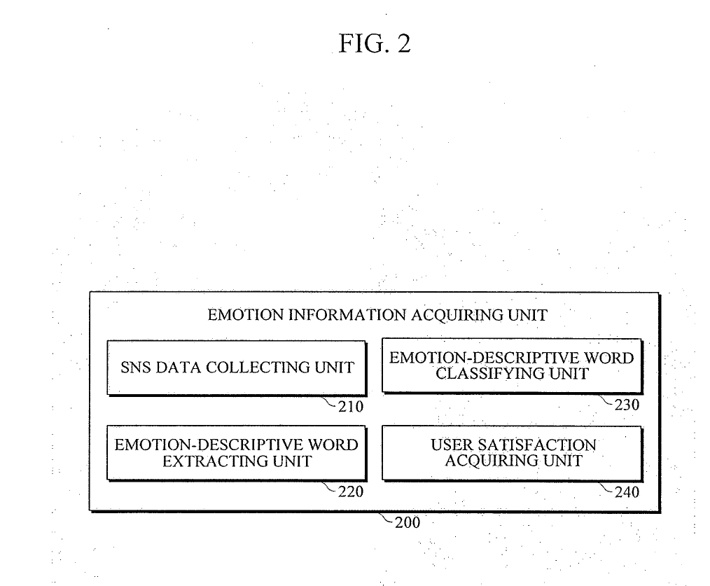

FIG. 2 is a diagram illustrating in detail the emotion information acquiring unit of FIG. 1.

Referring to FIG. 2, the emotion information acquiring unit 200 includes a social network service (SNS) data collecting unit 210, an emotion-descriptive word extracting unit 220, an emotion-descriptive word classifying unit 230, and a user satisfaction acquiring unit 240.

The SNS data collecting unit 210 may receive information from each user, the information including user's SNS list information and ID information, and manage the received information. In addition, based on the information, the SNS data collecting unit 210 may search for and collect messages that a particular user has posted in all social network services for a predetermined period of time.

The emotion-descriptive word extracting unit 220 may extract words describing emotions from the data collected by the SNS data collecting unit 210.

The emotion-descriptive word classifying unit 230 may categorize emotional states into N groups including a sad group, a happy group, an angry group, a sensitive group, and the like, and create an emotion-descriptive word classification list including the categorized groups.

The emotion-descriptive word extracting unit 220 and the emotion-descriptive word classifying unit 230 may utilize a text mining research result.

The user satisfaction acquiring unit 240 may obtain information about user satisfaction with content that the user has watched in a specific emotional state.

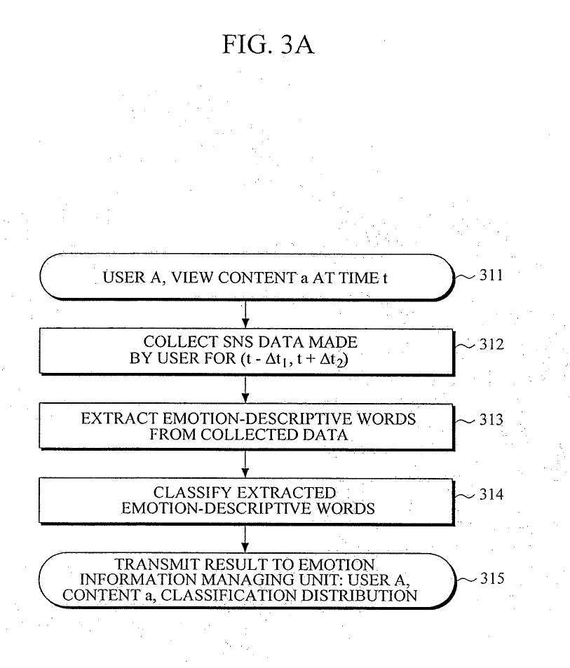

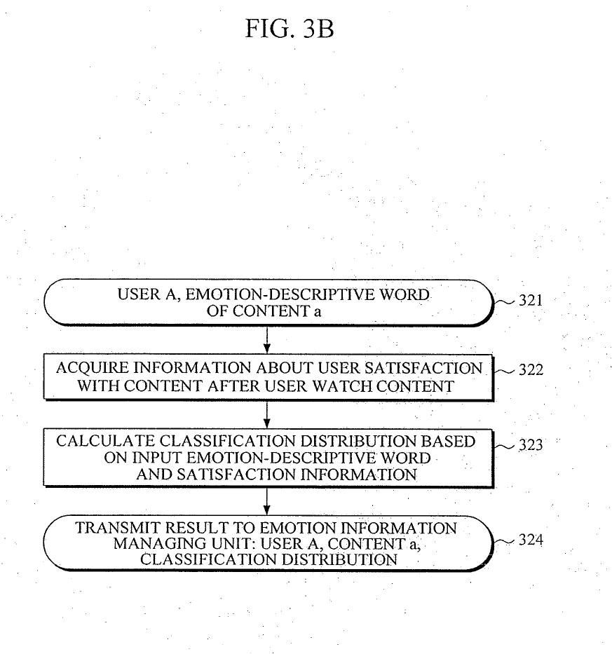

FIG. 3A is a flowchart illustrating a method of acquiring emotion information according to an exemplary embodiment of the present invention.

Referring to FIGS. 1 and 3A, if user A uses content a at time t in 311, the emotion information acquiring unit 200 detects a user's emotional state around the time t in 312 to 314, and notifies the detected emotional state to the emotion information managing unit 300 in 315.

Referring back to FIG. 2, in 312, the SNS data collecting unit 210 of the emotion information acquiring unit 200 collects data that the user has created in SNS for a predetermined period of time (t−Δt₁, t+Δt₂) before and after the time of watching the content. Thereafter, the emotion-descriptive word extracting unit 220 extracts words that describe emotions from the collected data in 313. Then, the emotion-descriptive word classifying unit 230 classifies the extracted words based on the emotion-descriptive word classification table, and creates classification distribution based on the classification result in 314.

The creation of the classification distribution in 314 will be described in detail below.

Under the assumption that there are N emotional states and X emotion-descriptive words are extracted, the number of emotion-descriptive words included in an i-th emotional state is represented as xᵢ. In this example, the classification distribution is expressed as a group of N data (α₁, α₂, . . . , and α_{N}) each data representing a ratio of the emotion-descriptive words corresponding to each emotional state to the entire number of the emotion-descriptive words, and an i-th value αᵢ is xᵢ/X. In this case, X=Σᵢ₌₁^{N}xᵢ and 1=Σᵢ₌₁^{N}αᵢ.

In addition, after the completion of the classification distribution, the emotion information acquiring unit 200 transmits information about the user and the content watched by the user along with the calculated classification distributions to the emotion information managing unit 300.

FIG. 3B is a flowchart illustrating a method of acquiring user satisfaction with recommendation after viewing recommended content.

The operations shown in FIG. 3B are performed when a user has watched content recommended by a system that received a request from the user for content search and recommendation based on an emotion-descriptive word. Various methods may be used to implement the determination of whether the recommended content has been watched. For example, the determination may be made that a recommended content is used or watched when the user attempts to use or view content among recommendations from a client program of a content recommendation service in a user terminal.

In another example, when the user requests the system for content search and recommendation based on an emotion-descriptive word, the system may store both request data and a recommendation result. In this case, the determination of whether the user has used the recommended content may be made by checking the stored data.

Referring back to FIG. 2, when it is determined that the user has used the recommended content, the user satisfaction acquiring unit 240 receives a user ID, a content ID and the emotion-descriptive word that is input for content search and recommendation in 321. The user satisfaction acquiring unit 240 stores the received information and requests a content providing system to notify completion of the content use. In response to the notification, the user satisfaction acquiring unit 240 requests and acquires satisfaction level information about the corresponding content from the user in 322.

If the user does not provide the requested information, the operation ends. If the user provides the satisfaction level information, updating of the emotion information is performed while taking into account the satisfaction information.

Generally, the information received from the user is broadly classified into two groups, a satisfaction group and a dissatisfaction group, and satisfaction information of each group may be received.

Based on the received information, the user satisfaction acquiring unit sets a satisfaction weight (SW). If there are four levels of the satisfaction and dissatisfaction groups, there are four SWs w1, w2, −w1, and −w2. w1 and w2 represent levels, and sign “−” indicates dissatisfaction.

In addition, the user satisfaction acquiring unit 240 calculates the emotion classification distribution using the method used in operation 314. By multiplying the calculated emotion classification distribution by the set SW, a final classification distribution is calculated in 323. Thereafter, the user and content IDs and the final classification distribution value are transmitted to the emotion information managing unit 300 in 324.

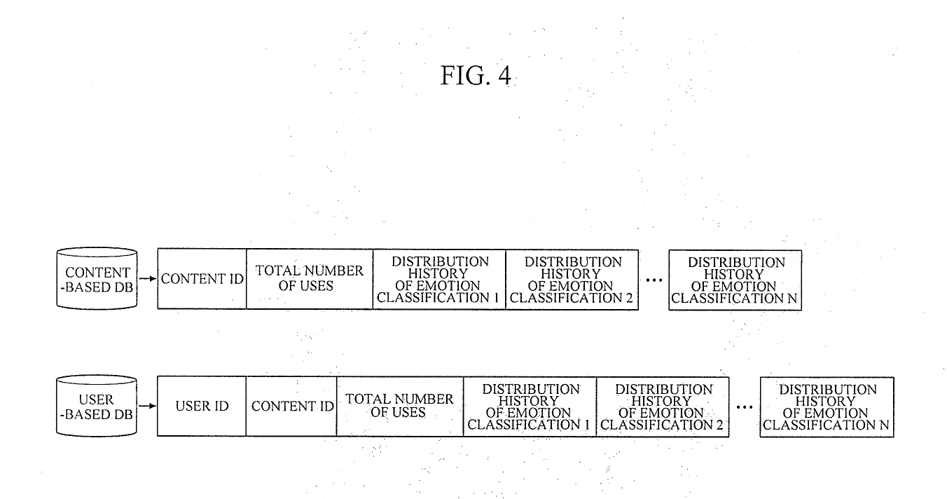

FIG. 4 is a diagram illustrating an example of a data table managed by the emotion information managing unit of FIG. 1.

The emotion information managing unit manages user IDs, content IDs, and emotion distribution values on a content-by-content basis and on a user-by-user basis. That is, the emotion information managing unit manages the information by conceptually dividing them into a content-based DB and a user-based DB.

The content-based DB manages information about overall emotion distribution history. The content-based DB comprehensively manages the total number of content uses and distributions of each of N emotional states on the basis of the content ID.

In contrast, the user-based DB comprehensively manages the number of uses of each content by each user and distributions of each of N emotional states on the basis of the user ID.

In this example, the total number of uses of content is increased by 1 in response to data incoming to the emotion information managing unit, resulting from the operations shown in FIGS. 3A and 3B. That is, the number of uses of content is increased by 1 when the emotion information is acquired at the time of content use or when satisfaction data is obtained with respect to the recommendation result.

The emotion distribution history is managed by accumulating the distribution results from the operations shown in FIGS. 3A and 3B. In this case, if the recommendation result is not satisfactory, the input distribution value is negative, and thus the accumulated result is reduced, and otherwise the accumulated result is increased.

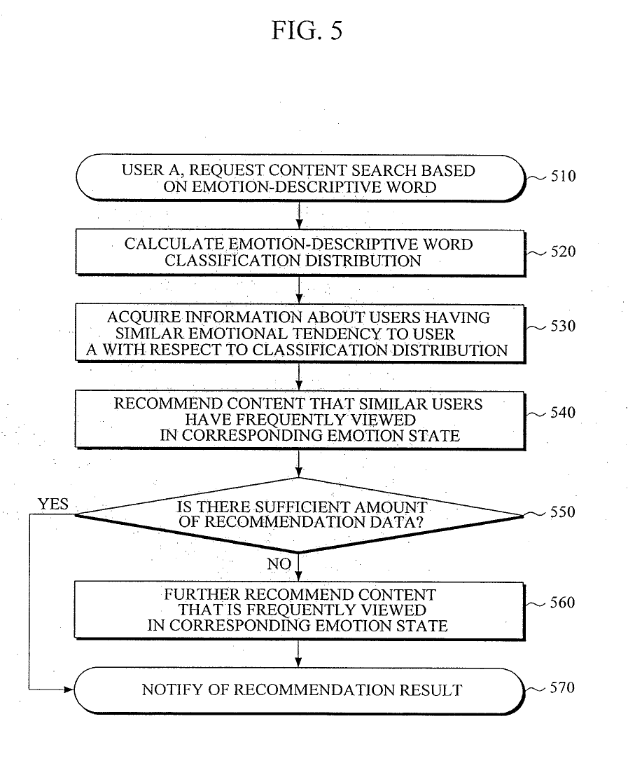

FIG. 5 is a flowchart illustrating a method of recommending content based on an emotion according to an exemplary embodiment of the present invention.

Referring to FIGS. 1 and 5, in 510, user A requests the emotion-based content recommending unit 400 to search for or recommend content using an emotion-descriptive word or a group of emotion-descriptive words. In response to the request, the emotion-based content recommending unit 400 calculates the classification distribution of the emotion-descriptive word or the group of emotion-descriptive words using the emotion-descriptive word classifying unit in the emotion information acquiring unit in 520.

Generally, since the content-based DB contains combined data of a number of users having different characteristics, the included content may show distinct features and have even distribution values with respect to a particular emotion classification or emotion classification group.

Thus, content recommendation based on users having a similar emotional tendency is given a higher priority. To this end, the emotion-based content recommending unit finds users showing a similar emotional tendency to that of the input user in 530.

In order to find the similar users who are more relevant to the current emotional state of the user, the emotion classification distribution calculated in 520 is used rather than the overall similarity of the emotional tendencies. The methods for finding the similar users may be the same methods as used in social networking.

For example, the similar users may be found by using content information commonly used in the emotional states similar to the input emotion distribution. In response to the similar user information being found, the emotion-based content recommending unit mainly recommends content that the similar users have frequently viewed in the emotional state corresponding to the calculated emotion distribution in 540. Such content recommendation method may employ existing recommendation algorithms so as to improve recommendation performance.

However, the similar-user-based content recommendation requires a great amount of accumulated history information. Without a sufficient amount of collected data, there may be no, or at least few, recommendation results.

If only a few recommendations are made in 550 because of an insufficient amount of collected history information, a further recommendation of content having been frequently viewed and showing the emotion classification distribution that is similar to the distribution calculated in 520 is made based on the content-based DB in 560. Then, the user is notified of the recommendation result in 570.

An example of a method for calculating the distribution of the similar emotion classification may include a method of converting each emotion classification distribution and the distribution calculated in 520 into N-dimensional normalized vectors.

For example, if the input emotion classification distribution is (α₁, α₂, . . . , and α_{N}) and an emotion classification distribution of content to be compared (or content viewed by a particular user) is (β₁, β₂, . . . , and β_{N}), a normalized vector converted from each distribution may be represented as follows.

V_{α}=<^{α}^{₁}/_{A},^{α}^{₂}/_{A′}, . . . ^{α}^{_{N}}/_{A}>,A=Σᵢ₌₁^{N}α₁

V_{α}=<^{α}^{₁}/_{A},^{α}^{₂}/_{A′}, . . . ^{α}^{_{N}}/_{A}>,A=Σᵢ₌₁^{X}α₁

In this case, a degree of similarity between two emotion distributions may be calculated using the inner product of a vector or a distance between vectors depending on system performances. For example, in the case of use of a distance between vectors, since the similarity increases as the distance is shorter, the degree of similarity can be measured by the reciprocal of the distance between vectors. In contrast, in the case of use of an inner product of a vector, the inner product itself may be used as the degree of similarity.

According to the above exemplary embodiments of the present invention, a recommendation of multimedia content can be adaptively made based on a user's emotional state.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An apparatus for recommending content based on a user's emotion, comprising:
an emotion information acquiring unit configured to acquire emotion information of a user before and after use of particular content;
an emotion information managing unit configured to store and manage emotion information corresponding to the particular content; and
a content recommending unit configured to search for and recommend content corresponding to an emotion-descriptive word which is input by the user to request content search.

2. The apparatus of claim 1, wherein the emotion information acquiring unit is configured to comprise
a social network service (SNS) data collecting unit configured to collect information that the user of the predetermined content has input in a social network,
an emotion-descriptive word extracting unit configured to extract emotion-descriptive words that describe emotions from the data collected by the data collecting unit, and
an emotion-descriptive word classifying unit configured to classify the emotion-descriptive words extracted by the emotion-descriptive word extracting unit into predetermined emotional states.

3. The apparatus of claim 2, wherein the SNS data collecting unit is configured to collect messages that a particular user has posted in social network services for a predetermined period of time, based on an identification (ID) and social network list information of the user.

4. The apparatus of claim 2, wherein the emotion-descriptive word classifying unit is configured to output emotion-descriptive word classification distribution values by generating classification distributions representing ratios of a number of emotion-descriptive words corresponding to each emotion state to the entire number of the extracted emotion-descriptive words.

5. The apparatus of claim 1, wherein the emotion information acquiring unit is configured to comprise a user satisfaction acquiring unit configured to acquire user satisfaction with recommended content.

6. The apparatus of claim 5, wherein the user satisfaction acquiring unit is configured to comprise an emotion-descriptive word input for content search, to issue a request for notification of completion of content use, and to issue a request to the user to acquire satisfaction information about the used content.

7. The apparatus of claim 5, wherein the user satisfaction acquiring unit is configured to receive satisfaction level information from the user, to set a satisfaction weight (SW), and to calculate a final classification distribution by multiplying an emotion classification distribution calculated based on the input emotion-descriptive word by the set SW.

8. The apparatus of claim 1, wherein the emotion information managing unit is configured to update information about user emotion distribution histories about content, and to manage a total number of uses of each content and the emotion distribution histories for each of a predetermined number of emotional states based on a content ID.

9. The apparatus of claim 1, wherein the emotion information managing unit is configured to manage a total number of uses of each content by each user and emotion distribution histories of each for each of a predetermined number of emotional states.

10. A method for recommending content based on a user's emotion by an apparatus for recommending content, comprising:
acquiring emotion information of a user before and after use of particular content;
storing emotion information corresponding to the particular content; and
searching for and recommending content corresponding to an emotion-descriptive word which is input by the user to request content search.

11. The method of claim 10, wherein the acquiring of the emotion information comprises
collecting information that the user of the predetermined content has input in a social network,
extracting emotion-descriptive words that describe emotions from the data collected by the data collecting unit, and
classifying the extracted emotion-descriptive words into predetermined emotional states.

12. The method of claim 10, further comprising:
acquiring user satisfaction with recommended content.
